(19) United States
(12) Patent Application Publication
(10) Pub. No.: US 2023/0170201 A1
(43) Pub. Date: Jun. 1, 2023

(54) SAMPLE SUPPORT, IONIZATION METHOD, AND MASS SPECTROMETRY METHOD

(71) Applicants: HAMAMATSU PHOTONICS K.K., Hamamatsu-shi, Shizuoka (JP); TAIYO NIPPON SANSO CORPORATION, Shinagawa-ku, Tokyo (JP); NATIONAL UNIVERSITY CORPORATION FUKUSHIMA UNIVERSITY, Fukushima-shi, Fukushima (JP)

(72) Inventors: Masahiro KOTANI, Hamamatsu-shi, Shizuoka (JP); Takayuki OHMURA, Hamamatsu-shi, Shizuoka (JP); Akari WAKIMURA, Shinagawa-ku, Tokyo (JP); Tsutomu TERAUCHI, Shinagawa-ku, Tokyo (JP); Shu TAIRA, Fukushima-shi, Fukushima (JP); Yasuhide NAITO, Hamamatsu-shi, Shizuoka (JP)

(73) Assignees: HAMAMATSU PHOTONICS K.K., Hamamatsu-shi, Shizuoka (JP); TAIYO NIPPON SANSO CORPORATION, Shinagawa-ku, Tokyo (JP); NATIONAL UNIVERSITY CORPORATION FUKUSHIMA UNIVERSITY, Fukushima-shi, Fukushima (JP)

(21) Appl. No.: 17/921,189

(22) PCT Filed: Apr. 15, 2021
(86) PCT No.: PCT/JP2021/015636

§ 371 Date: Oct. 25, 2022

(30) Foreign Application Priority Data
May 1, 2020 (JP) 2020-081184

(51) Int. Cl. H01J 49/04; H01J 49/00; H01J 49/16

(52) U.S. Cl. CPC H01J 49/0409; H01J 49/0031; H01J 49/164

(57) ABSTRACT

A sample support is a sample support used for ionizing components of a sample, and includes: a substrate including a first surface, a second surface on a side opposite to the first surface, and a plurality of through holes opening to the first surface and the second surface; a conductive layer provided at least on the first surface; and a derivatizing agent provided to the plurality of through holes to derivatize the components.

### TECHNICAL FIELD

The present disclosure relates to a sample support, an ionization method, and a mass spectrometry method.

### BACKGROUND ART

A sample support provided with a substrate including a first surface, a second surface on a side opposite to the first surface, and a plurality of through holes opening to the first surface and the second surface is known as a sample support used for ionizing components of a sample (for example, refer to Patent Literature 1).

### CITATION LIST

### Patent Literature

Patent Literature 1: Japanese Patent No. 6093492

### SUMMARY OF INVENTION

### Technical Problem

In mass spectrometry using the sample support as described above, there is a case where the intensity of a signal to be detected decreases in accordance with the type of sample that is an analysis target, and in such a case, the sensitivity of the mass spectrometry may decrease.

Therefore, an object of the present disclosure is to provide a sample support, an ionization method, and a mass spectrometry method in which high-sensitive mass spectrometry is enabled.

### Solution to Problem

A sample support of the present disclosure is a sample support used for ionizing components of a sample, and includes: a substrate including a first surface, a second surface on a side opposite to the first surface, and a plurality of through holes opening to the first surface and the second surface; a conductive layer provided at least on the first surface; and a derivatizing agent provided to the plurality of through holes to derivatize the components.

Such a sample support is provided with the substrate including the first surface, the second surface on a side opposite to the first surface, and the plurality of through holes opening to the first surface and the second surface. Accordingly, in a case where the components of the sample are introduced to the plurality of through holes, the components remain on the first surface side. Further, in a case of irradiating the first surface of the substrate with an energy beam such as laser light while applying a voltage to the conductive layer, energy is transferred to the components on the first surface side. The components are ionized by the energy, and sample ions are generated. Here, the sample support includes the derivatizing agent provided to the plurality of through holes to derivatize the components. Accordingly, the components remain on the first surface side in a state of being mixed with a part of the derivatizing agent. Accordingly, the components can be derivatized in a state of remaining on the first surface side, and the derivatized components can be ionized. Therefore, since the ionized sample ions are easily detected, a decrease in the intensity of signals of the sample ions is suppressed. Therefore, according to such a sample support, high-sensitive mass spectrometry is enabled.

In the sample support of the present disclosure, the derivatizing agent may be provided as a coated and dried film. According to such a configuration, the derivatizing agent can be easily provided.

In the sample support of the present disclosure, the derivatizing agent may be provided as an evaporated film or a sputtered film. According to such a configuration, an average particle diameter of crystals of the derivatizing agent can be relatively decreased, and the distribution of the crystals of the derivatizing agent can be homogeneous. Accordingly, a part of the derivatizing agent that is mixed with the components is homogeneously distributed on the first surface side. Accordingly, the components can be homogeneously derivatized in each position of the first surface side, and spatial resolving power of mass spectrometry can be increased.

In the sample support of the present disclosure, the derivatizing agent may contain at least one selected from a pyrylium compound, a carbamate compound, an isothiocyanate compound, N-hydroxysuccinimide ester, and a hydrazide compound. According to such a configuration, by applying the derivatizing agent suitable for the derivatization of the components of the sample in accordance with the type of sample, the components can be efficiently derivatized.

The sample support of the present disclosure may further include a basifying agent configured to basify an environment in which the components are derivatized. According to such a configuration, the environment in which the components are derivatized can be easily basified, and the components can be easily derivatized.

In the sample support of the present disclosure, the derivatizing agent may be provided on the second surface side, and the basifying agent may be provided on the first surface side. According to such a configuration, damage or a side reaction of the derivatizing agent due to contact with the basifying agent can be suppressed. In addition, by introducing the components of the sample to the plurality of through holes from the second surface side, contact between the components and the basifying agent can be suppressed. Accordingly, damage or a side reaction of the components due to the contact with the basifying agent can be suppressed.

In the sample support of the present disclosure, the derivatizing agent may be provided on the first surface side, and the basifying agent may be provided on the second surface side. According to such a configuration, the damage or the side reaction of the derivatizing agent due to the contact with the basifying agent can be suppressed. In addition, by introducing the components of the sample to the plurality of through holes from the first surface side, the contact between the components and the basifying agent can be suppressed. Accordingly, the damage or the side reaction of the components due to the contact with the basifying agent can be suppressed.

In the sample support of the present disclosure, the basifying agent may be provided as a coated and dried film. According to such a configuration, the basifying agent can be easily provided.

In the sample support of the present disclosure, the basifying agent may be provided as an evaporated film or a sputtered film. According to such a configuration, an average particle diameter of crystals of the basifying agent can be relatively decreased, and the distribution of the crystals of the basifying agent can be homogeneous. Accordingly, the environment in which the components are derivatized can be easily basified.

In the sample support of the present disclosure, the basifying agent may contain at least one selected from amines, imines, inorganic bases, an amine-based buffer, an imine-based buffer, and an inorganic base-based buffer. According to such a configuration, by applying the basifying agent suitable for the derivatization of the components of the sample in accordance with the type of sample and the type of derivatizing agent, the components can be efficiently derivatized.

In the sample support of the present disclosure, a width of each of the plurality of through holes may be 1 to 700 nm. According to such a configuration, the components of the sample can be suitably retained on the first surface side of the substrate.

In the sample support of the present disclosure, the substrate may be formed by anodizing a valve metal or silicon. According to such a configuration, the substrate including the plurality of through holes can be easily and reliably obtained.

In the sample support of the present disclosure, a plurality of measurement regions respectively including the plurality of through holes may be formed on the substrate. According to such a configuration, the components of the sample can be ionized for each of the plurality of measurement regions.

A sample support of the present disclosure is a sample support used for ionizing components of a sample, and includes: a conductive substrate including a first surface, a second surface on a side opposite to the first surface, and a plurality of through holes opening to the first surface and the second surface; and a derivatizing agent provided to the plurality of through holes to derivatize the components.

According to such a sample support, a conductive layer can be omitted, and the same effects as those of the sample support including the conductive layer as described above can be obtained.

An ionization method of the present disclosure, includes: a first step of preparing a sample support including a derivatizing agent; a second step of introducing components of a sample to a plurality of through holes; a third step of derivatizing the components by heating the sample support with the components introduced therein in a basic environment; and a fourth step of ionizing the components by irradiating a first surface with an energy beam while applying a voltage to a conductive layer.

In such an ionization method, in a case where the components of the sample are introduced to the plurality of through holes, the components remain on the first surface side. Further, in a case of irradiating the first surface of a substrate with the energy beam while applying a voltage to the conductive layer, energy is transferred to the components on the first surface side. The components are ionized by the energy, and sample ions are generated. Here, the sample support includes the derivatizing agent provided to the plurality of through holes to derivatize the components. Accordingly, the components remain on the first surface side in a state of being mixed with a part of the derivatizing agent. Accordingly, by heating the sample support in the basic environment in a state where the components remain on the first surface side, the components can be derivatized, and the derivatized components can be ionized. Therefore, since the ionized sample ions are easily detected, a decrease in the intensity of signals of the sample ions is suppressed. Therefore, according to such a sample support, high-sensitive mass spectrometry is enabled.

In the ionization method of the present disclosure, in the second step, the sample support may be disposed on the sample such that a second surface faces the sample. Accordingly, imaging mass spectrometry can be high-sensitive imaging mass spectrometry. That is, since the components of the sample are moved to the first surface side from the second surface side through each of the through holes, in the components moved to the first surface side, position information of the sample (two-dimensional distribution information of molecules configuring the sample) is maintained. In such a state, in a case of irradiating the first surface with the energy beam while applying a voltage to the conductive layer, the components are ionized while maintaining the position information of the sample. Accordingly, a definition of an image in the imaging mass spectrometry can be improved.

In the ionization method of the present disclosure, in the second step, a solution containing the components may be dropped to the plurality of through holes from the second surface side. Accordingly, in a case where the derivatizing agent and the substrate have higher affinity for the solution than the conductive layer, the solution can be smoothly introduced to the plurality of through holes, compared to a case where the solution is dropped to the plurality of through holes from the first surface side of the substrate.

In the ionization method of the present disclosure, in the second step, a solution containing the components may be dropped to the plurality of through holes from the first surface side. Accordingly, since both of the introduction of the solution and the irradiation of the energy beam can be performed from the first surface side, in each of the steps, the sample support may not be reversed. Accordingly, an operation in each of the steps may be facilitated.

An ionization method of the present disclosure, includes: a first step of preparing a sample support including a derivatizing agent and a basifying agent; a second step of introducing components of a sample to a plurality of through holes; a third step of derivatizing the components by heating the sample support with the components introduced therein; and a fourth step of ionizing the components by irradiating a first surface with an energy beam while applying a voltage to a conductive layer.

In such an ionization method, in the first step, the sample support including the basifying agent is prepared. Accordingly, an environment in which the components are derivatized can be easily basified, and the components can be easily derivatized.

In the ionization method of the present disclosure, in the first step, the sample support may be prepared in which the derivatizing agent is provided on the second surface side, and the basifying agent is provided on the first surface side, and in the second step, the sample support may be disposed on the sample such that the second surface faces the sample. Accordingly, damage or a side reaction of the derivatizing agent due to contact with the basifying agent can be suppressed. In addition, since the components of the sample are introduced to the plurality of through holes from the second surface side, contact between the components and the basifying agent can be suppressed, and damage or a side reaction of the components due to the contact with the basifying agent can be suppressed.

In the ionization method of the present disclosure, in the first step, the sample support may be prepared in which the derivatizing agent is provided on the second surface side, and the basifying agent is provided on the first surface side, and in the second step, a solution containing the components may be dropped to the plurality of through holes from the second surface side. Accordingly, the damage or the side reaction of the derivatizing agent due to the contact with the basifying agent can be suppressed. In addition, since the components of the sample are introduced to the plurality of through holes from the second surface side, the contact between the components and the basifying agent can be suppressed, and the damage or the side reaction of the components due to the contact with the basifying agent can be suppressed.

In the ionization method of the present disclosure, in the first step, the sample support may be prepared in which the derivatizing agent is provided on the first surface side, and the basifying agent is provided on the second surface side, and in the second step, a solution containing the components may be dropped to the plurality of through holes from the first surface side. Accordingly, the damage or the side reaction of the derivatizing agent due to the contact with the basifying agent can be suppressed. In addition, since the components of the sample are introduced to the plurality of through holes from the first surface side, the contact between the components and the basifying agent can be suppressed, and the damage or the side reaction of the components due to the contact with the basifying agent can be suppressed.

An ionization method of the present disclosure, includes: a first step of preparing a sample support including a conductive substrate; a second step of introducing components of a sample to a plurality of through holes; a third step of derivatizing the components by heating the sample support with the components introduced therein in a basic environment; and a fourth step of ionizing the components by irradiating a first surface with an energy beam while applying a voltage to the substrate.

According to such an ionization method, a conductive layer can be omitted, and the same effects as those in a case of using the sample support including the conductive layer as described above can be obtained.

A mass spectrometry method of the present disclosure, includes: each of the steps of the ionization method described above; and a fifth step of detecting the ionized components.

According to such a mass spectrometry method, as described above, high-sensitive mass spectrometry is enabled.

### Advantageous Effects of Invention

According to the present disclosure, it is possible to provide a sample support, an ionization method, and a mass spectrometry method in which high-sensitive mass spectrometry is enabled.

### BRIEF DESCRIPTION OF DRAWINGS

FIG. 1 is a plan view of a sample support of a first embodiment.

FIG. 2 is a sectional view of the sample support along line II-II illustrated in FIG. 1.

FIG. 3 is an enlarged image of a substrate of the sample support illustrated in FIG. 1.

FIG. 4 is a diagram illustrating steps of a mass spectrometry method using the sample support illustrated in FIG. 1.

FIG. 5 is a diagram illustrating steps of the mass spectrometry method using the sample support illustrated in FIG. 1.

FIG. 6 is a plan view and a sectional view of a sample support of a second embodiment.

FIG. 7 is a sectional view of the sample support illustrated in FIG. 6.

FIG. 8 is a diagram illustrating steps of a mass spectrometry method using the sample support illustrated in FIG. 6.

FIG. 9 is a diagram illustrating mass spectrums obtained by a mass spectrometry method of each of Comparative Example, First Example, and Second Example.

FIG. 10 is a sectional view of a sample support of Modification Example.

FIG. 11 is a sectional view of a sample support of Modification Example.

FIG. 12 is a diagram illustrating two-dimensional distribution image of specific ions obtained by a mass spectrometry method of Third Example.

FIG. 13 is a sectional view of a sample support of Modification Example.

FIG. 14 is a sectional view of a sample support of Modification Example.

FIG. 15 is a sectional view of a sample support of Modification Example.

FIG. 16 is a diagram illustrating steps of a mass spectrometry method of Modification Example.

FIG. 17 is a diagram illustrating steps of the mass spectrometry method of Modification Example.

### DESCRIPTION OF EMBODIMENTS

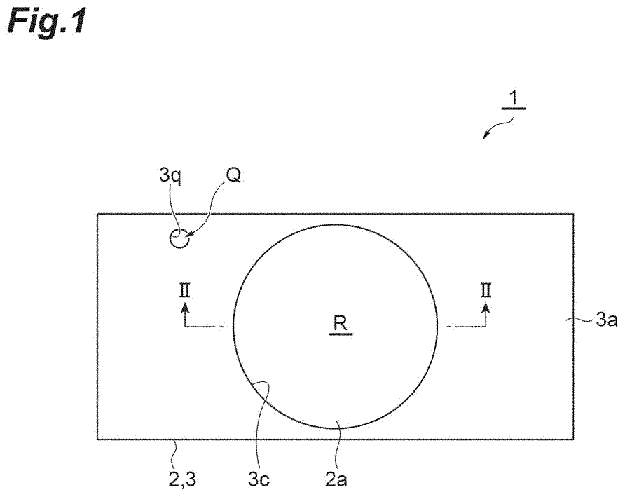

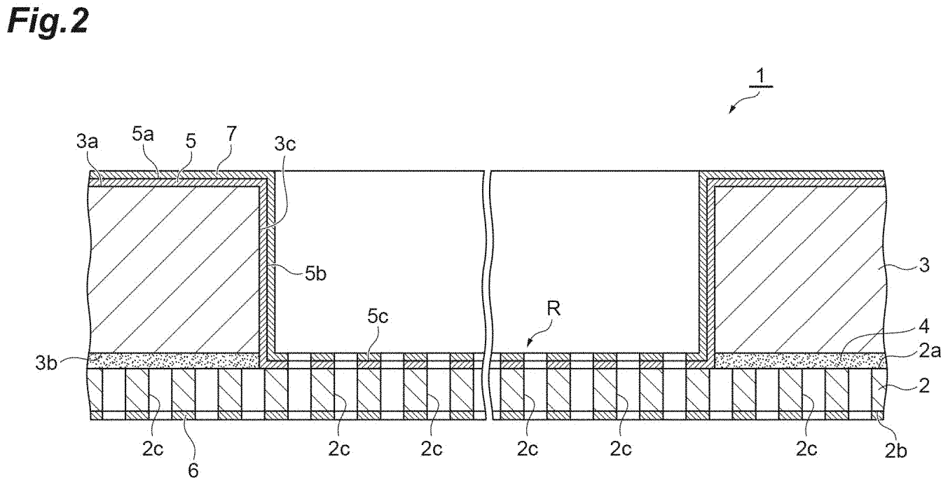

Hereinafter, embodiments of the present disclosure will be described in detail with reference to the drawings. Note that, in each of the drawings, the same reference numerals will be applied to the same or corresponding parts, and the repeated description will be omitted.

[First Embodiment] [Configuration of Sample Support] As illustrated in FIG. 1 and FIG. 2, a sample support 1 used for ionizing components of a sample includes a substrate 2, a frame 3, a conductive layer 5, a derivatizing agent 6, and a basifying agent 7. The substrate 2, for example, is formed in a rectangular plate shape with an insulating material. The length of one side of the substrate 2, for example, is approximately several cm. The thickness of the substrate 2, for example, is 1 to 50 μm. The substrate 2 includes a first surface 2a, a second surface 2b, and a plurality of through holes 2c. The second surface 2b is a surface on a side opposite to the first surface 2a.

The plurality of through holes 2c extend along a thickness direction of the substrate 2 (a direction perpendicular to the first surface 2a and the second surface 2b), and open to each of the first surface 2a and the second surface 2b. In this embodiment, the plurality of through holes 2c are formed in the substrate 2 uniformly (in a homogeneous distribution). The shape of the through hole 2c when seen from the thickness direction of the substrate 2, for example, is approximately a circular shape. The width of each of the plurality of through holes 2c, for example, is 1 to 700 nm.

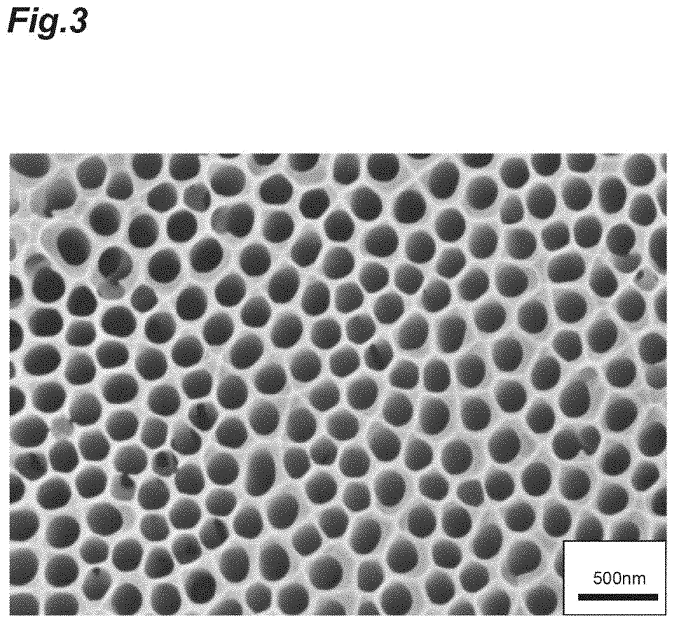

The width of the through hole 2c is a value to be acquired as follows. First, an image of each of the first surface 2a and the second surface 2b of the substrate 2 is acquired. FIG. 3 illustrates an example of a SEM image of a part of the first surface 2a of the substrate 2. In the SEM image, a black part is the through hole 2c, and a white part is a partition between the through holes 2c. Subsequently, by performing, for example, binarization processing to the acquired image of the first surface 2a, a plurality of pixel groups corresponding to a plurality of first apertures (apertures of the through hole 2c on the first surface 2a side) in a measurement region R are extracted, and the diameter of a circle having an average area of the first apertures is acquired on the basis of a size per one pixel. Similarly, by performing, for example, binarization processing to the acquired image of the second surface 2b, a plurality of pixel groups corresponding to a plurality of second apertures (apertures of the through holes 2c on the second surface 2b side) in the measurement region R are extracted, and diameter of a circle having an average area of the second apertures is acquired on the basis of a size per one pixel. Then, an average value of the diameter of the circle acquired for the first surface 2a and the diameter of the circle acquired for the second surface 2b is acquired as the width of the through hole 2c.

As illustrated in FIG. 3, in the substrate 2, the plurality of through holes 2c having approximately a constant width are uniformly formed. It is preferable that an aperture ratio of the through holes 2c in the measurement region R (a ratio of all of the through holes 2c to the measurement region R when seen from the thickness direction of the substrate 2) is practically 10 to 80%, and particularly 20 to 40%. The sizes of the plurality of through holes 2c may not be identical to each other, or the plurality of through holes 2c may be partially connected to each other.

The substrate 2 illustrated in FIG. 3 is an alumina porous film that is formed by anodizing aluminum (Al). Specifically, the substrate 2 can be obtained by performing an anodization treatment to an Al substrate and by peeling off the oxidized surface portion from the Al substrate. Note that, the substrate 2 may be formed by anodizing valve metals other than Al, such as tantalum (Ta), niobium (Nb), titanium (Ti), hafnium (Hf), zirconium (Zr), zinc (Zn), tungsten (W), bismuth (Bi), and antimony (Sb), or may be formed by anodizing silicon (Si).

As illustrated in FIG. 1 and FIG. 2, the frame 3 has approximately the same outline as that of the substrate 2 when seen from the thickness direction of the substrate 2. The frame 3 includes a third surface 3a and a fourth surface 3b, and an aperture 3c and an aperture 3q. The fourth surface 3b is a surface on a side opposite to the third surface 3a, and is a surface on the substrate 2 side. The aperture 3c and the aperture 3q open to the third surface 3a and the fourth surface 3b, respectively. The area (the width) of the aperture 3q is smaller than the area (the width) of the aperture 3c when seen from the thickness direction of the substrate 2. The frame 3 is attached to the substrate 2. In this embodiment, the first surface 2a of the substrate 2 and the fourth surface 3b of the frame 3 are fixed to each other by an adhesive layer 4. The material of the adhesive layer 4, for example, is an adhesive material having a small amount of emitted gas (low-melting glass, a vacuum adhesive agent, and the like).

In the sample support 1, a portion in the substrate 2 corresponding to the aperture 3c of the frame 3 functions as the measurement region R for moving the components of the sample to the first surface 2a side from the second surface 2b side through the plurality of through holes 2c. That is, the measurement region R includes the plurality of through holes 2c. In the sample support 1, a portion in the substrate 2 corresponding to the aperture 3q of the frame 3 functions as a quantitative region Q for performing quantitative mass spectrometry. The quantitative region Q includes the plurality of through holes 2c. The area (the width) of the quantitative region Q is smaller than the area (the width) of the measurement region R when seen from the thickness direction of the substrate 2. According to such a frame 3, the handling of the sample support 1 is facilitated, and the deformation of the substrate 2 due to a temperature change or the like is suppressed.

The conductive layer 5 is provided on the first surface 2a side of the substrate 2. The conductive layer 5 is provided on the first surface 2a directly (that is, without another film or the like). Specifically, the conductive layer 5 is continuously (integrally) formed on a region in the first surface 2a of the substrate 2 corresponding to the aperture 3c and the aperture 3q of the frame 3 (that is, a region corresponding to the measurement region R and the quantitative region Q), the inner surface of each of the aperture 3c and the aperture 3q, and the third surface 3a of the frame 3. In each of the measurement region R and the quantitative region Q, the conductive layer 5 covers a portion in the first surface 2a of the substrate 2 in which the through hole 2c is not formed. That is, in the measurement region R, each of the through holes 2c is exposed to the aperture 3c, and in the quantitative region Q, each of the through holes 2c is exposed to the aperture 3q. Note that, the conductive layer 5 may be provided on the first surface 2a indirectly (that is, with another film or the like).

The conductive layer 5 may contain a conductive material. Here, as the material of the conductive layer 5, it is preferable to use a metal having low affinity (reactivity) for the sample and high conductivity for the following reasons.

For example, in a case where the conductive layer 5 contains a metal such as copper (Cu), having high affinity for the sample such as protein, in an ionization process of the sample, the sample is ionized in a state where Cu atoms are attached to sample molecules, and as a result thereof, the ionized sample is detected as Cu-added molecules, and there may be a deviation in a detection result. Therefore, as the material of the conductive layer 5, it is preferable to use a noble metal having low affinity for the sample.

On the other hand, as the metal has higher conductivity, a constant voltage is more easily and stably applied. Accordingly, in a case where the conductive layer 5 contains a metal having high conductivity, in each of the measurement region R and the quantitative region Q, a voltage can be homogeneously applied to the first surface 2a of the substrate 2. In addition, a metal that is capable of efficiently transferring the energy of the energy beam (for example, laser light or the like) with which the substrate 2 is irradiated to the sample through the conductive layer 5 is preferable as the material of the conductive layer 5. For example, in a case where the substrate 2 is irradiated with standard laser light that is used in matrix-assisted laser desorption/ionization (MALDI) or the like (for example, triple harmonic Nd having a wavelength of approximately 355 nm, YAG laser, nitrogen laser having a wavelength of approximately 337 nm, or the like), Al, gold (Au), platinum (Pt), or the like having high absorptivity in an ultraviolet region is preferable as the material of the conductive layer 5.

From the above viewpoint, as the material of the conductive layer 5, for example, it is preferable to use Au, Pt, or the like. In this embodiment, the material of the conductive layer 5 is Pt. The conductive layer 5, for example, is formed to have a thickness of approximately 1 nm to 350 nm by a plating method, atomic layer deposition (ALD), an evaporation method, a sputtering method, or the like. In this embodiment, the thickness of the conductive layer 5, for example, is approximately 20 nm. Note that, for example, chromium (Cr), nickel (Ni), titanium (Ti), and the like may be used as the material of the conductive layer 5.

The derivatizing agent 6 is provided to the plurality of through holes 2c. The derivatizing agent 6 being provided to the plurality of through holes 2c indicates that the derivatizing agent 6 is provided in the vicinity of each of the through holes 2c. In this embodiment, the derivatizing agent 6 is provided on the second surface 2b side of the substrate 2. The derivatizing agent 6 is directly provided on the second surface 2b. The derivatizing agent 6 covers a region in the second surface 2b in which the plurality of through holes 2c are not formed. A part of the derivatizing agent 6 can be melted (mixed) in the components of the sample, a solvent, or the like.

The derivatizing agent 6 derivatizes the components of the sample by a derivatization reaction with the components of the sample. The derivatizing agent 6 contains at least one selected from a pyrylium compound, a carbamate compound, an isothiocyanate compound, N-hydroxysuccinimide ester, and a hydrazide compound. The pyrylium compound, for example, is a pyrylium salt. The pyrylium compound, for example, is a tetrafluoroborate of pyrylium, a sulfoacetate of pyrylium, a trifluoromethane sulfonate of pyrylium, or the like. In addition, the pyrylium compound, for example, is a 2,4,6-trimethyl pyrylium tetrafluoroborate, a 2,4,6-triethyl-3,5-dimethyl pyrylium trifluoromethane sulfonate, or the like. The carbamate compound, for example, is 6-aminoquinolyl-N-hydroxysuccinimidyl carbamate (AQC), p-dimethyl aminoanilyl-N-hydroxysuccinimidyl carbamate (DAHS), 3-aminopyridyl-N-hydroxysuccinimidyl carbamate (APDS), p-trimethyl ammonium anilyl-N-hydroxysuccinimidyl carbamate iodide (TAHS), aminopyrazyl-N-hydroxysuccinimidyl carbamate, 9-aminoacridyl-N-hydroxysuccinimidyl carbamate, 1-naphthyl amino-N-hydroxysuccinimidyl carbamate, or the like. The isothiocyanate compound, for example, is phenyl isothiocyanate, fluorescein isothiocyanate, or the like. The hydrazide compound, for example, is 2,4-dinitrophenyl hydrazine, dansyl hydrazine, 4-(N,N-dimethyl aminosulfonyl)-7-hydrazino-2,1,3-benzoxadiazole, 4-hydrazino-7-nitro-2,1,3-benzoxadiazole hydrazine, trimethyl acetohydrazide ammonium chloride, 1-(hydrazinocarbonyl methyl) pyridinium chloride, N,N-dimethyl glycine hydrazide dihydrochloride, or the like. In addition, a low-molecular compound having charges and high reactivity with the components of the sample (an analysis target) (for example, 2,4,6-trimethyl pyrylium tetrafluoroborate, 2,4,6-triethyl-3,5-dimethyl pyrylium trifluoromethane sulfonate, or the like) is more preferable as the derivatizing agent 6. Accordingly, the sensitivity of mass spectrometry can be improved. The derivatizing agent 6 is provided as a coated and dried film. Specifically, the derivatizing agent 6, for example, is formed by applying a liquid material containing the derivatizing agent 6 to the substrate 2 with a spray or the like, and then, by drying the liquid material. The thickness of the derivatizing agent 6, for example, is approximately 50 to 100 μm. The derivatizing agent 6 has crystallizability. An average particle diameter of crystals of the derivatizing agent 6, for example, is approximately 20 to 100 μm.

The average particle diameter of the crystals of the derivatizing agent 6 is a value to be acquired by SEM. Specifically, first, a SEM image of the derivatizing agent 6 is acquired. Subsequently, by performing, for example, binarization processing to the acquired image of the derivatizing agent 6, a plurality of pixel groups corresponding to a plurality of crystals of the derivatizing agent 6 are extracted, and the diameter of a circle having an average area of the plurality of crystals is acquired as the average particle diameter of the plurality of crystals, on the basis of a size per one pixel.

The basifying agent 7 is provided on the first surface 2a side of the substrate 2. The basifying agent 7 is indirectly provided on the first surface 2a. The basifying agent 7 is provided on the first surface 2a through the conductive layer 5. The basifying agent 7 is directly provided on the surface of the conductive layer 5 on a side opposite to the substrate 2. Specifically, the basifying agent 7 is continuously (integrally) provided on a surface 5c of the conductive layer 5 formed in the region corresponding to each of the measurement region R and the quantitative region Q, a surface 5b of the conductive layer 5 formed on the inner surface of each of the aperture 3c and the aperture 3q, and a surface 5a of the conductive layer 5 formed on the third surface 3a of the frame 3. In each of the measurement region R and the quantitative region Q, the basifying agent 7 covers a portion in the surface 5c of the conductive layer 5 in which the through hole 2c is not formed. That is, in the measurement region R, each of the through holes 2c is exposed to the aperture 3c, and in the quantitative region Q, each of the through holes 2c is exposed to the aperture 3q.

The basifying agent 7 basifies an environment (a reaction field) in which the components of the sample are derivatized. In a case where the basifying agent 7, for example, is heated together with water, a part of the basifying agent 7 is mixed with moisture vapor, and basifies the ambient atmosphere of the sample support 1 (at least a space in which the components of the sample are derivatized). As the basifying agent 7, it is preferable to use a basifying agent that is less likely to be volatilized at a manufacturing or storing temperature and has excellent compound stability. Specifically, the basifying agent 7 contains at least one selected from amines, imines, inorganic bases, an amine-based buffer, an imine-based buffer, and an inorganic base-based buffer. The basifying agent 7, for example, is a boric acid buffer or N,N-dimethyl aminopyridine. The basifying agent 7 is provided as a coated and dried film. Specifically, the basifying agent 7, for example, is formed by applying a liquid material containing the basifying agent 7 to the conductive layer 5 with a spray or the like, and then, by drying the liquid material. The thickness of the basifying agent 7, for example, is approximately 50 to 100 μm. The basifying agent 7 has crystallizability. An average particle diameter of crystals of the basifying agent 7, for example, is approximately 20 to 100 μm. The average particle diameter of the crystals of the basifying agent 7 is a value to be acquired by SEM, as with the derivatizing agent 6. Note that, in FIG. 1, the conductive layer 5 and the basifying agent 7 are not illustrated.

[Ionization Method and Mass Spectrometry Method] Next, an ionization method and a mass spectrometry method using the sample support 1 will be described. First, the sample support 1 is prepared (a first step). The sample support 1 may be prepared by the manufacturing of an executor of the ionization method and the mass spectrometry method, or may be prepared by being transferred from a manufacturer, a seller, or the like of the sample support 1.

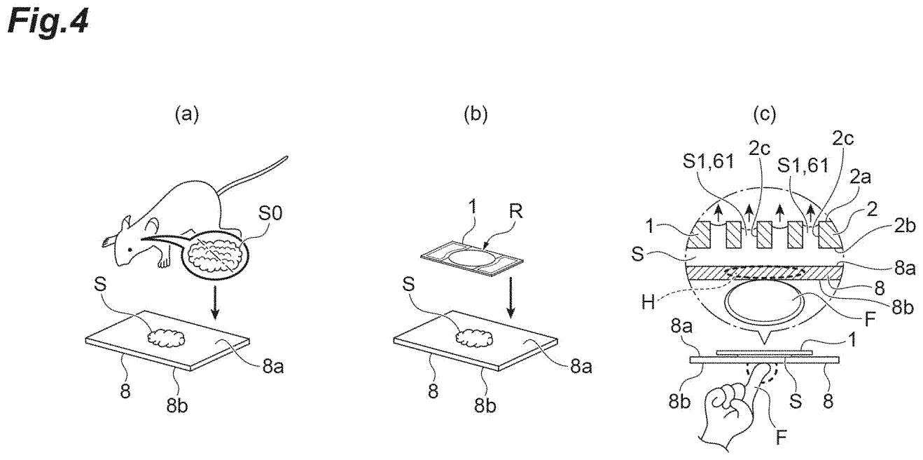

Subsequently, as illustrated in (a) and (b) in FIG. 4, components S1 of a sample S ((c) in refer to FIG. 4) are introduced to the plurality of through holes 2c of the sample support 1 (a second step). Specifically, the sample S is disposed on a mounting surface 8a of a glass slide (a mounting portion) 8. The glass slide 8 is a glass substrate on which a transparent conductive film such as an indium tin oxide (ITO) film is formed, and the mounting surface 8a is the surface of the transparent conductive film. Note that, instead of the glass slide 8, a member that is capable of ensuring conductivity (for example, a substrate containing a metal material such as stainless steel, or the like) may be used as the mounting portion. The sample S, for example, is a thin film-shaped biological sample (a hydrous sample) such as a tissue slice, and is in a frozen state. In this embodiment, the sample S is acquired by slicing a brain S0 of a mouse. Subsequently, the sample support 1 is disposed on the sample S such that the second surface 2b of the sample support 1 (refer to FIG. 2) faces the sample S and the derivatizing agent 6 (refer to FIG. 2) is in contact with the sample S. In this case, the sample support 1 is disposed such that the sample S is positioned in the measurement region R when seen from the thickness direction of the substrate 2.

Subsequently, the sample support 1 is fixed to the glass slide 8 by using a tape having conductivity (for example, a carbon tape or the like). Subsequently, as illustrated in (c) in FIG. 4, a finger F is in contact with a rear surface 8b of the glass slide 8 (a surface on a side opposite to the mounting surface 8a). Accordingly, heat H of the finger F is transferred to the sample S through the glass slide 8, and the sample S is defrosted. In a case where the sample S is defrosted, the components S1 of the sample S are mixed with a part 61 of the derivatizing agent 6 and are moved to the first surface 2a side from the second surface 2b side through the plurality of through holes 2c, for example, by the capillary action, and for example, remain on the first surface 2a side by a surface tension. That is, the components S1 of the sample S remain on the first surface 2a side in a state of being mixed with the part 61 of the derivatizing agent 6. Note that, a solution containing a measurement sample for performing quantitative mass spectrometry is dropped to the quantitative region Q.

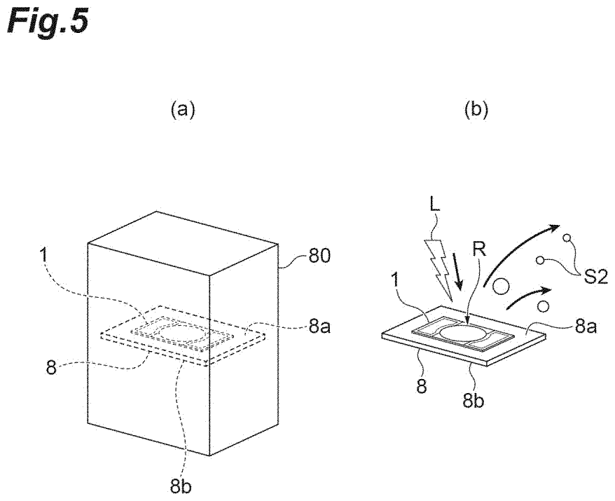

Subsequently, as illustrated in (a) in FIG. 5, the components S1 are derivatized by heating the sample support 1 to which the components S1 are introduced (a third step). Specifically, the glass slide 8 on which the sample S and the sample support 1 are disposed is carried in the inner space of a constant temperature bath 80. The constant temperature bath 80, for example, is a column constant temperature bath, and the inner space can be maintained in a predetermined temperature range. A predetermined amount (for example, approximately 1 ml) of water (not illustrated) is disposed on the inner space of the constant temperature bath 80. The water, for example, is disposed in a state of being absorbed in a waste cloth such as Kimwipes (Registered Trademark).

Subsequently, the constant temperature bath 80, for example, is activated for approximately 15 minutes such that the temperature of the inner space of the constant temperature bath 80, for example, is approximately 70° C. Accordingly, the water absorbed in Kimwipes is evaporated, and the inner space of the constant temperature bath 80 is set to a moisture vapor atmosphere. In addition, a part of the basifying agent 7 is mixed with moisture vapor, and the ambient atmosphere of the basifying agent 7 (a space including at least the first surface 2a of the substrate 2, in which the components 51 are derivatized) is basified. In the inner space of the constant temperature bath 80, the sample support 1 is heated in the moisture vapor atmosphere. Accordingly, a derivatization reaction of the components S1 remaining on the first surface 2a side progresses in a state of being mixed with the part 61 of the derivatizing agent 6.

Subsequently, as illustrated in (b) in FIG. 5, the glass slide 8 on which the sample S and the sample support 1 are disposed is carried out from the constant temperature bath 80, and the components S1 are ionized (a fourth step). Specifically, the glass slide 8 on which the sample S and the sample support 1 are disposed is disposed on a support portion (for example, a stage) of a mass spectroscope. Subsequently, a region in the first surface 2a of the of the substrate 2 corresponding to the measurement region R is irradiated with laser light (an energy beam) L by operating a laser light irradiation unit of the mass spectroscope while applying a voltage to the conductive layer 5 of the sample support 1 through the mounting surface 8a of the glass slide 8 and the tape by operating a voltage applying unit of the mass spectroscope. In this case, the region corresponding to the measurement region R is scanned with the laser light L by operating at least one of the support portion and the laser light irradiation unit.

As described above, in a case of irradiating the first surface 2a of the substrate 2 with the laser light L while applying a voltage to the conductive layer 5, since energy is transferred to the components S1 that are moved to the first surface 2a side and derivatized, and the components S1 are ionized, sample ions S2 (the ionized components S1) are generated. The steps described above correspond to the ionization method using the sample support 1 (in this embodiment, a laser desorption/ionization method).

Subsequently, the emitted sample ions S2 are detected by an ion detection unit of the mass spectroscope (a fifth step). Specifically, the emitted sample ions S2 are acceleratingly moved toward a ground electrode provided between the sample support 1 and the ion detection unit, in accordance with a potential difference between the conductive layer 5 to which a voltage is applied and the ground electrode, and are detected by the ion detection unit. Then, a two-dimensional distribution of molecules configuring the sample S is imaged by the ion detection unit detecting the sample ions S2 to correspond to a scanning position of the laser light L. The mass spectroscope is a scanning mass spectroscope using time-of-flight mass spectrometry (TOF-MS). The steps described above correspond to the mass spectrometry method using the sample support 1.

[Function and Effect] As described above, the sample support 1 is provided with the substrate 2 including the first surface 2a, the second surface 2b on a side opposite to the first surface 2a, and the plurality of through holes 2c opening to the first surface 2a and the second surface 2b. Accordingly, in a case where the components S1 are introduced to the plurality of through holes 2c, the components S1 remain on the first surface 2a side. Further, in a case of irradiating the first surface 2a of the substrate 2 with the energy beam such as the laser light L while applying a voltage to the conductive layer 5, energy is transferred to the components S1 on the first surface 2a side. The components S1 are ionized by the energy, and the sample ions S2 are generated. Here, the sample support 1 includes the derivatizing agent 6 provided in the plurality of through holes 2c to derivatize the components S1. Accordingly, the components S1 remain on the first surface 2a side in a state of being mixed with the part 61 of the derivatizing agent 6. Accordingly, the components S1 can be derivatized in a state where the components S1 remain on the first surface 2a side, and the derivatized components S1 can be ionized. Therefore, since the ionized sample ions S2 are easily detected, a decrease in the intensity of signals of the sample ions S2 is suppressed. Therefore, according to the sample support 1, high-sensitive mass spectrometry is enabled. Specifically, for example, the limit of the concentration of the sample S can be extended. That is, even in a case where the amount of components S1 remaining on the first surface 2a of the substrate 2 is relatively small, a decrease in the intensity of the signals of the sample ions S2 can be suppressed, and the sensitivity of the mass spectrometry can be improved.

In addition, in the sample support 1, the derivatizing agent 6 is provided as the coated and dried film. According to such a configuration, the derivatizing agent 6 can be easily provided. That is, for example, compared to a case where the derivatizing agent 6 is provided as an evaporated film or the like, a facility or the like for providing the evaporated film or the like can be omitted.

In addition, in the sample support 1, the derivatizing agent 6 contains at least one selected from the pyrylium compound, the carbamate compound, the isothiocyanate compound, the N-hydroxysuccinimide ester, and the hydrazide compound. According to such a configuration, by applying the derivatizing agent 6 suitable for the derivatization of the components S1 of the sample S in accordance with the type of sample S, the components S1 can be efficiently derivatized.

In addition, the sample support 1 includes the basifying agent 7 for basifying an environment in which the components S1 are derivatized. According to such a configuration, the environment in which the components S1 are derivatized can be easily basified, and the components S1 can be easily derivatized. However, in a case where the sample support does not include the basifying agent 7, for example, by heating the sample support on which the sample is disposed together with a volatile basic reagent such as triethyl amine when derivatizing the components S1 of the sample S, the entire inner space of the constant temperature bath 80 is set to a basic atmosphere. In such a case, the constant temperature bath 80, for example, is disposed in a draft chamber and activated. This is because the executor of the mass spectrometry method may inhale basic moisture vapor emitted from the inner space when carrying out the sample support 1 from the constant temperature bath 80. According to the configuration described above, since the sample support 1 includes the basifying agent 7 (in a trace amount), the entire inner space of the constant temperature bath 80 is prevented from being set to the basic atmosphere when derivatizing the components S1 of the sample S. Therefore, even in a case where the constant temperature bath 80 is not disposed in the draft chamber, the executor of the mass spectrometry method can be prevented from inhaling the basic moisture vapor. Therefore, the derivatization of the sample S can be facilitated, and a cost reduction can be attained.

In addition, in the sample support 1, the derivatizing agent 6 is provided on the second surface 2b side, and the basifying agent 7 is provided on the first surface 2a side. In a case where the sample S and the derivatizing agent 6 are in contact with the basifying agent 7, there may be damage or a side reaction. According to the configuration described above, the damage or the side reaction of the derivatizing agent 6 due to the contact with the basifying agent 7 can be suppressed. In addition, by introducing the components S1 to the plurality of through holes 2c from the second surface 2b side, the contact between the components S1 and the basifying agent 7 can be suppressed. Accordingly, the damage or the side reaction of the components S1 due to the contact with the basifying agent 7 can be suppressed.

In addition, in the sample support 1, the basifying agent 7 is provided as the coated and dried film. According to such a configuration, the basifying agent 7 can be easily provided. That is, for example, compared to a case where the basifying agent 7 is provided as an evaporated film or the like, a facility or the like for providing the evaporated film or the like can be omitted.

In addition, in the sample support 1, the basifying agent 7 contains at least one selected from the amines, the imines, the inorganic bases, the amine-based buffer, the imine-based buffer, and the inorganic base-based buffer. According to such a configuration, by applying the basifying agent 7 suitable for the derivatization of the components S1 of the sample S in accordance with the type of sample S and the type of derivatizing agent 6, the components S1 can be efficiently derivatized.

In addition, in the sample support 1, the width of each of the plurality of through holes 2c is 1 to 700 nm. According to such a configuration, the components S1 can be suitably retained on the first surface 2a side of the substrate 2.

In addition, in the sample support 1, the substrate 2 is formed by anodizing the valve metal or the silicon. According to such a configuration, the substrate 2 including the plurality of through holes 2c can be easily and reliably obtained.

In addition, according to the ionization method and the mass spectrometry method, as described above, high-sensitive mass spectrometry is enabled.

In addition, in the second step of the ionization method, the sample support 1 is disposed on the sample S such that the second surface 2b faces the sample S. Accordingly, imaging mass spectrometry can be high-sensitive imaging mass spectrometry. That is, since the components S1 are moved to the first surface 2a side from the second surface 2b side through each of the through holes 2c, in the components S1 moved to the first surface 2a side, position information of the sample S (two-dimensional distribution information of the molecules configuring the sample S) is maintained. In such a state, in a case of irradiating the first surface 2a with the laser light L while applying a voltage to the conductive layer 5, the components S1 are ionized while maintaining the position information of the sample S. Accordingly, a definition of an image in the imaging mass spectrometry can be improved.

In addition, in the first step of the ionization method, the sample support 1 including the basifying agent 7 is prepared. Accordingly, the environment in which the components S1 are derivatized can be easily basified, and the components S1 can be easily derivatized.

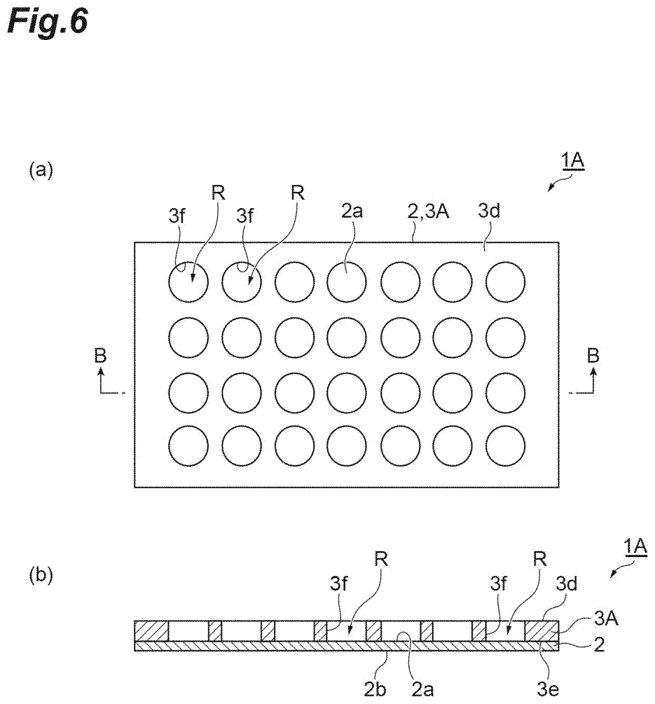

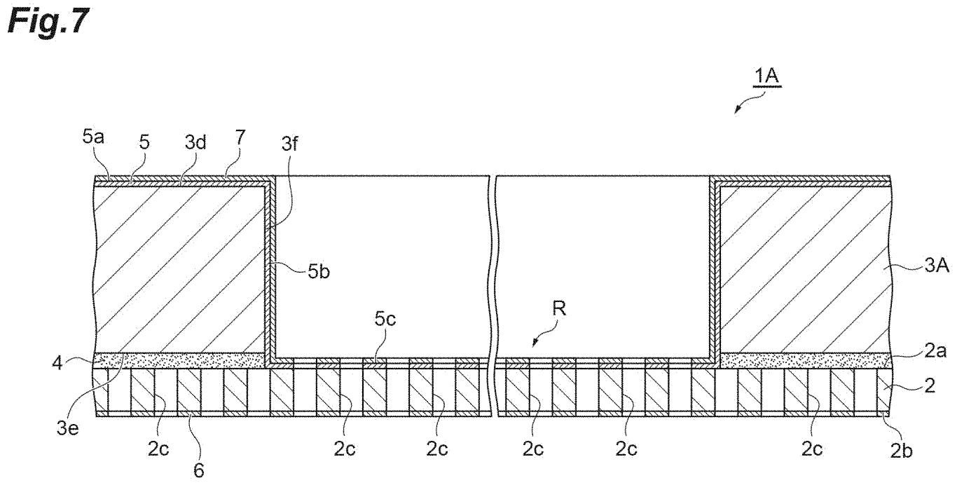

In addition, in the first step of the ionization method, the sample support 1 is prepared in which the derivatizing agent 6 is provided on the second surface 2b side, and the basifying agent 7 is provided on the first surface 2a side, and in the second step, the sample support 1 is disposed on the sample S such that the second surface 2b faces the sample S. Accordingly, the damage or the side reaction of the derivatizing agent 6 due to the contact with the basifying agent 7 can be suppressed. In addition, since the components S1 are introduced to the plurality of through holes 2c from the second surface 2b side, the contact between the components S1 and the basifying agent 7 can be suppressed, and the damage or the side reaction of the components S1 due to the contact with the basifying agent 7 can be suppressed.

[Second Embodiment] [Configuration of Sample Support] As illustrated in (a) in FIG. 6, (b) in FIG. 6, and FIG. 7, a sample support lA of a second embodiment is mainly different from the sample support 1 of the first embodiment in that a frame 3A is provided instead of the frame 3.

The sample support 1A includes the substrate 2, the frame 3A, the conductive layer 5, the derivatizing agent 6, and the basifying agent 7. The frame 3A includes a third surface 3d, a fourth surface 3e, and a plurality of apertures 3f. The plurality of apertures 3f define a plurality of measurement regions R, respectively. That is, the plurality of measurement regions R are formed on the substrate 2. In each of the measurement regions R, the sample S is disposed.

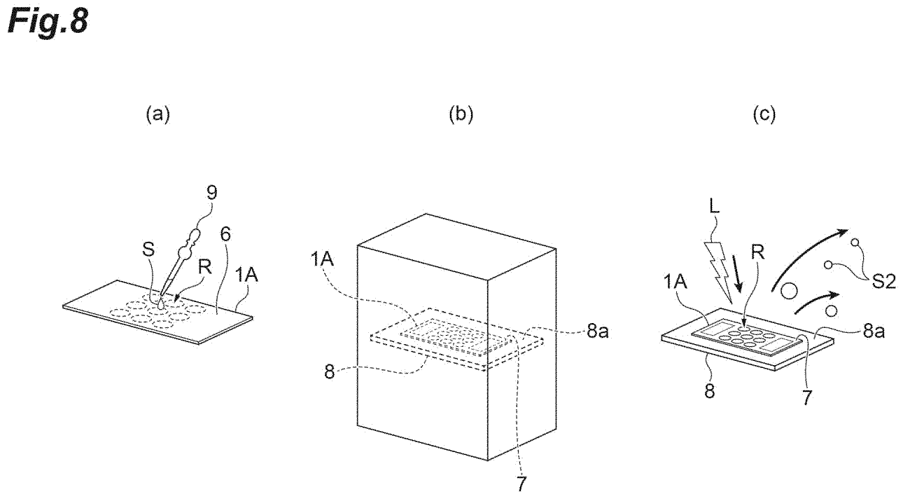

The basifying agent 7 is provided on the first surface 2a side of the substrate 2. The basifying agent 7 is indirectly provided on the first surface 2a. The basifying agent 7 is provided on the first surface 2a through the conductive layer 5. The basifying agent 7 is directly provided on the surface of the conductive layer 5 on a side opposite to the substrate 2. Specifically, the basifying agent 7 is continuously (integrally) provided on the surface 5c of the conductive layer 5 formed in a region corresponding to each of the measurement regions R, the surface 5b of the conductive layer 5 formed on the inner surface of each of the apertures 3f, and the surface 5a of the conductive layer 5 formed on the third surface 3d of the frame 3. In each of the measurement regions R, the basifying agent 7 covers a portion in the surface 5c of the conductive layer 5 in which the through hole 2c is not formed. That is, in each of the measurement regions R, each of the through holes 2c is exposed to the aperture 3f. Note that, in (a) and (b) in FIG. 6, the adhesive layer 4, the conductive layer 5, the derivatizing agent 6, and the basifying agent 7 are not illustrated.

[Ionization Method and Mass Spectrometry Method] Next, an ionization method and a mass spectrometry method using the sample support 1A will be described. First, as illustrated in (a) in FIG. 8, the sample support 1A is prepared (a first step). Subsequently, the components of the sample S (refer to FIG. 7) are introduced to the plurality of through holes 2c of the sample support 1A (a second step). Specifically, the sample S is disposed in each of the measurement regions R of the sample support 1A. In this embodiment, for example, by using a pipette 9, a solution containing the components of the sample S is dropped to the plurality of through holes 2c of each of the measurement regions R from the second surface 2b side of the substrate 2 (refer to FIG. 7). That is, the solution containing the components of the sample S is dropped to a surface on which the derivatizing agent 6 is provided. Specifically, in a state where the sample support 1 is supported such that the second surface 2b is positioned on the upper side with respect to the first surface 2a (the derivatizing agent 6), the solution is dropped to the second surface 2b.

Subsequently, in a state where the sample support 1 is supported such that the second surface 2b is positioned on the upper side with respect to the first surface 2a, the solution is moved into the plurality of through holes 2c from the second surface 2b side. Specifically, by maintaining the state in which the second surface 2b is positioned on the upper side with respect to the first surface 2a, the solution is moved into the through hole 2c by the gravity and the capillary action. Accordingly, the solution is mixed with a part of the derivatizing agent 6, and is moved to the first surface 2a side from the second surface 2b side of the substrate 2 through the plurality of through holes 2c. The solution remains on the first surface 2a side in a state of being mixed with a part of the derivatizing agent 6. Here, in a case where both of the derivatizing agent 6 and the substrate 2 have higher affinity for water than both of the basifying agent 7 and the conductive layer 5, by dropping the solution to the second surface 2b, the sample solution is capable of smoothly flowing into the through hole 2c, compared to a case where the solution is dropped to the first surface 2a.

Subsequently, as illustrated in (b) in FIG. 8, the sample support 1 is reversed such that the first surface 2a (the basifying agent 7) is positioned on the upper side with respect to the second surface 2b, is mounted on the mounting surface 8a of the glass slide 8 in a state where the first surface 2a is positioned on the upper side with respect to the second surface 2b, and is carried in the inner space of the constant temperature bath 80 together with the glass slide 8. The sample support 1 is mounted on the mounting surface 8a such that the second surface 2b faces the mounting surface 8a. Subsequently, the components of the sample S are derivatized (a third step). Subsequently, as illustrated in (c) in FIG. 8, the glass slide 8 on which the sample support 1 is disposed is carried out from the constant temperature bath 80, and in a state where the first surface 2a is positioned on the upper side with respect to the second surface 2b, the components of the sample S are ionized (a fourth step). The steps described above correspond to the ionization method using the sample support 1A. Subsequently, the emitted sample ions S2 are detected by the ion detection unit of the mass spectroscope (a fifth step). By the ion detection unit detecting the sample ions S2, a mass spectrum of the molecules configuring the sample S is acquired. The steps described above correspond to the mass spectrometry method using the sample support 1A.

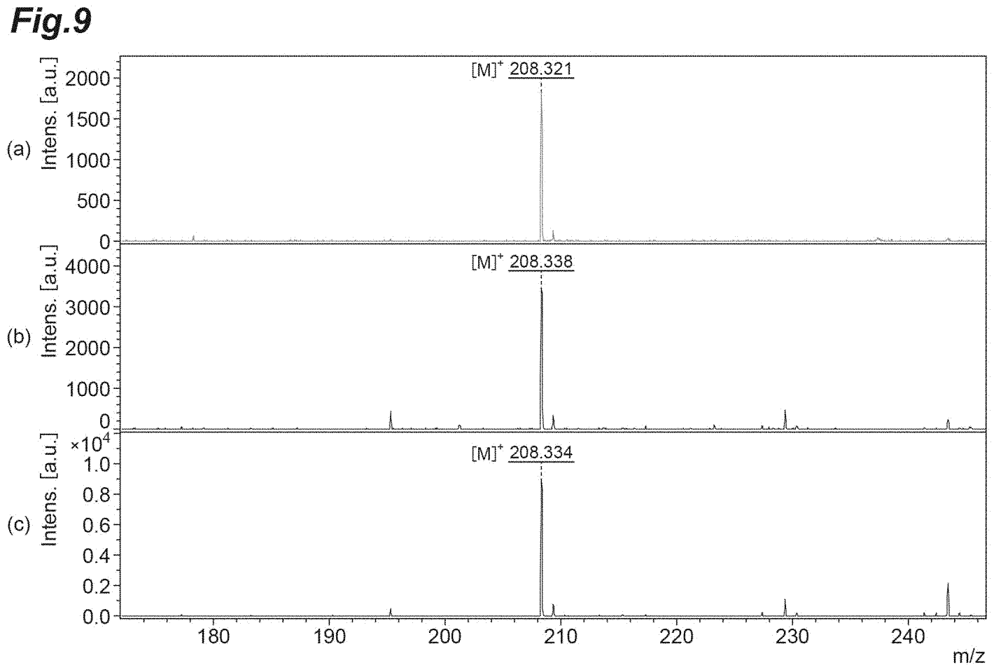

As described above, according to the sample support 1A, as with the sample support 1, high-sensitive mass spectrometry is enabled. (a) in FIG. 9 is a diagram illustrating a mass spectrum obtained by a mass spectrometry method of Comparative Example. (b) and (c) in FIG. 9 are diagrams illustrating mass spectrums obtained by mass spectrometry methods of First Example and Second Example, respectively. A sample support used in the mass spectrometry method of Comparative Example is different from the sample support 1A in that the derivatizing agent 6 and the basifying agent 7 are not provided. In Comparative Example, a solution containing the derivatized components of the sample was dropped to the plurality of through holes 2c of the sample support, and then, the components of the sample were ionized. In First Example, a solution containing the components of the sample was dropped to the plurality of through holes 2c of the sample support 1A, and the components were derivatized, and then, ionized. In Second Example, a solution containing the components of the sample was absorbed in the plurality of through holes 2c from the second surface 2b side of the substrate 2, and the components were derivatized, and then, ionized. In each of First Example and Second Example, glycine was used as the sample S, 2,4,6-trimethyl pyrylium tetrafluoroborate was used as the derivatizing agent 6, and a boric acid buffer was used as the basifying agent 7. As illustrated in (a) to (c) in FIG. 9, the detected intensity of the ions in the mass spectrometry method of First Example and Second Example is greater than the detected intensity of the ions in the mass spectrometry method of Comparative Example.

In addition, in the sample support 1A, the plurality of measurement regions R respectively including the plurality of through holes 2c are formed on the substrate 2. According to such a configuration, the components of the sample S can be ionized for each of the plurality of measurement regions R.

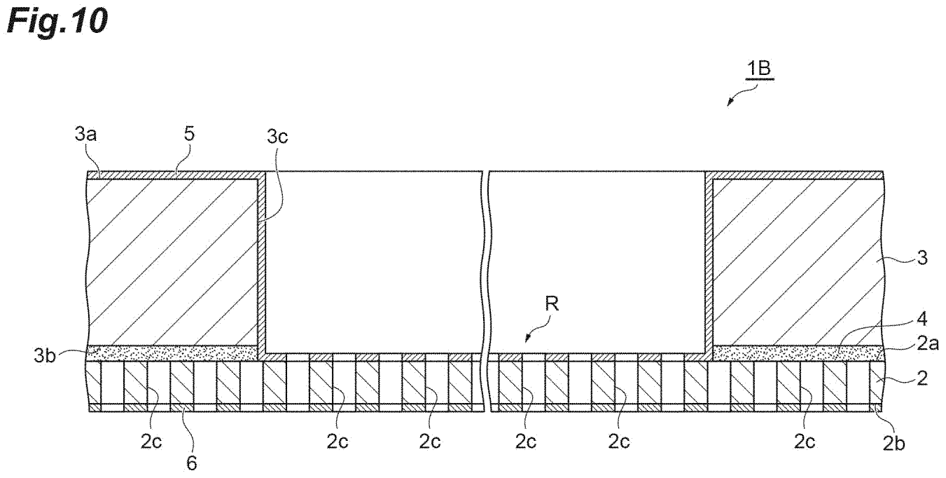

In addition, in the first step of the ionization method, the sample support lA is prepared in which the derivatizing agent 6 is provided on the second surface 2b side, and the basifying agent 7 is provided on the first surface 2a side, and in the second step, the solution containing the components of the sample S is dropped to the plurality of through holes 2c from the second surface 2b side. Accordingly, the damage or the side reaction of the derivatizing agent 6 due to the contact with the basifying agent 7 can be suppressed. In addition, since the solution is introduced to the plurality of through holes 2c from the second surface 2b side, the contact between the components of the sample S and the basifying agent 7 can be suppressed, and the damage or the side reaction of the components of the sample S due to the contact with the basifying agent 7 can be suppressed.

[Modification Example] The present disclosure is not limited to each of the embodiments described above. In the first embodiment, an example has been described in which the sample support 1 includes the basifying agent 7, but the sample support may not include the basifying agent 7. Hereinafter, sample supports 1B to 1E not including the basifying agent 7 will be described. The sample supports 1B to 1E are mainly different from the sample support 1 in that the basifying agent 7 is not provided. As illustrated in FIG. 10, in the sample support 1B, the derivatizing agent 6 may be provided on the second surface 2b side, and the basifying agent 7 may not be provided on the first surface 2a side.

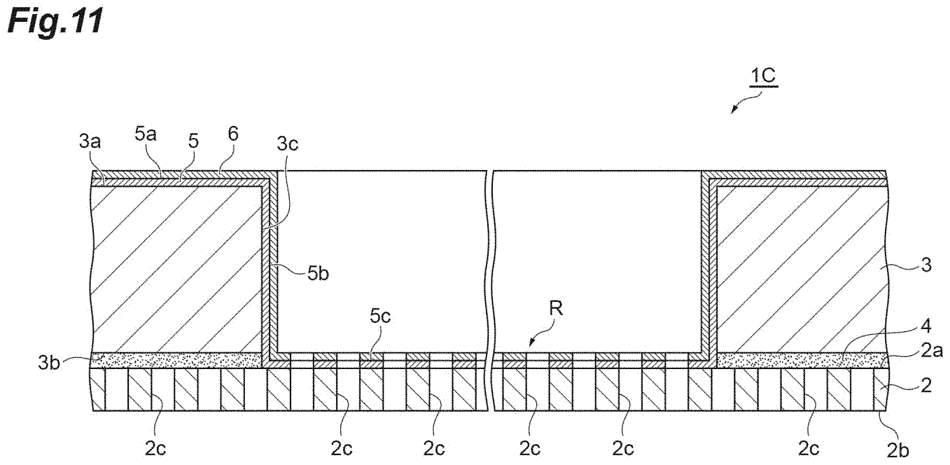

In addition, as illustrated in FIG. 11, in the sample support 1C, the derivatizing agent 6 may be provided on the first surface 2a side. The derivatizing agent 6 is indirectly provided on the first surface 2a. The derivatizing agent 6 is provided on the first surface 2a through the conductive layer 5. The derivatizing agent 6 is directly provided on the surface of the conductive layer 5 on a side opposite to the substrate 2. Specifically, the derivatizing agent 6 is continuously (integrally) provided on the surface 5c of the conductive layer 5 formed in the region corresponding to each of the measurement region R and the quantitative region Q, the surface 5b of the conductive layer 5 formed on the inner surface of each of the aperture 3c and the aperture 3q, and the surface 5a of the conductive layer 5 formed on the third surface 3a of the frame 3. In each of the measurement region R and the quantitative region Q, the derivatizing agent 6 covers a portion in the surface 5c of the conductive layer 5 in which the through hole 2c is not formed. That is, in the measurement region R, each of the through holes 2c is exposed to the aperture 3c, and in the quantitative region Q, each of the through holes 2c is exposed to the aperture 3q.

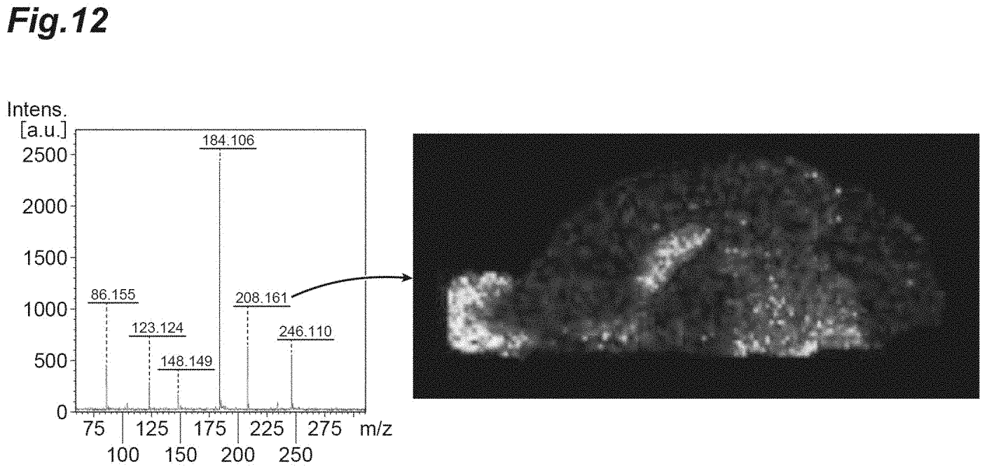

FIG. 12 is a diagram illustrating a two-dimensional distribution image of specific ions obtained by a mass spectrometry method of Third Example. In Third Example, as with the mass spectrometry method using the sample support 1 (refer to FIG. 4 and FIG. 5) described above, mass spectrometry was performed by using the sample support 1C. In Third Example, 2,4,6-trimethyl pyrylium tetrafluoroborate was used as the derivatizing agent 6. Note that, in Third Example, the sample support 1C to which the components S1 (here, glycine) are introduced is carried in the inner space of the constant temperature bath 80 together with Kimwipes or the like in which triethyl amine or the like that is a basic reagent having volatility (a basifying agent) is absorbed. Accordingly, in a case where the constant temperature bath 80 is activated, the basic reagent absorbed in Kimwipes is gasified, and the inner space of the constant temperature bath 80 is set to a basic environment (a basic atmosphere). Further, in a case where the sample support 1C is heated in the basic environment, the derivatization reaction of the components S1 remaining on the first surface 2a side progresses in a state of being mixed with the part 61 of the derivatizing agent 6. In Third Example, as illustrated in FIG. 12, as a result of acquiring an image of a two-dimensional distribution of the molecular weight (m/z 208) of the sample S, the distribution of the molecular weight was capable of being checked.

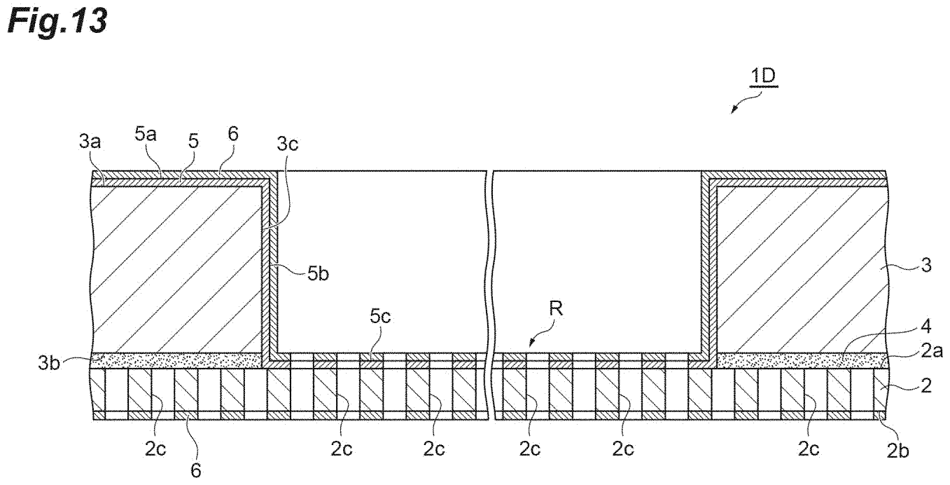

In addition, as illustrated in FIG. 13, in the sample support 1D, the derivatizing agent 6 may be provided on the second surface 2b side as with the sample support 1B, and may be provided on the first surface 2a side as with the sample support 1C.

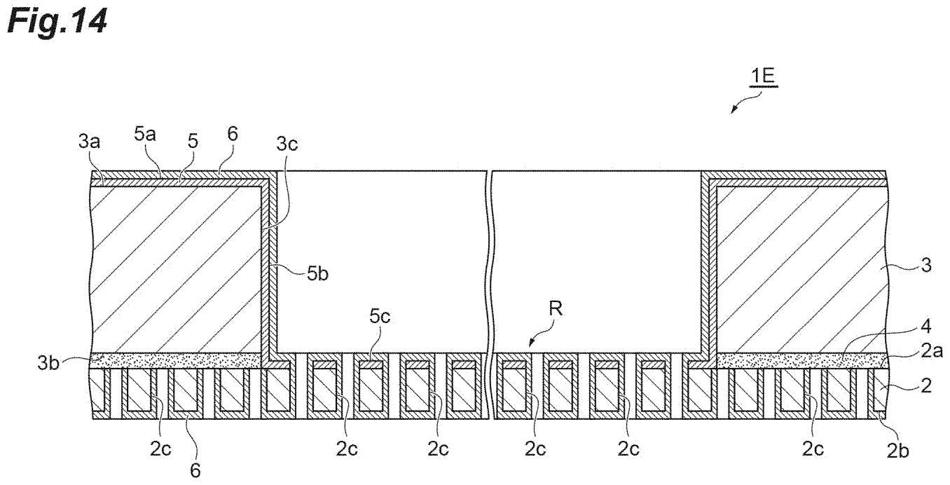

In addition, as illustrated in FIG. 14, in the sample support 1E, the derivatizing agent 6 may be provided on the second surface 2b side as with the sample support 1B, may be provided on the first surface 2a side as with the sample support 1C, and may be provided on the inner surface of the plurality of through holes 2c. The derivatizing agent 6 is directly provided on the inner surface of the plurality of through holes 2c. In this case, the derivatizing agent 6 has a thickness that does not block the through hole 2c. That is, since the thickness of the derivatizing agent 6 is sufficiently small, the conductive layer 5 is capable of suitably functioning. In addition, the derivatizing agent 6 may be provided only on the inner surface of the plurality of through holes 2c. Note that, the derivatizing agent 6 may be indirectly provided on the inner surface of the plurality of through holes 2c, for example, through a conductive layer or the like. In addition, the derivatizing agent 6 may be formed by dip coating.

Even in the second embodiment, the sample support may not include the basifying agent 7, as with the sample supports 1B to 1E.

In the third step of the mass spectrometry method using the sample support not including the basifying agent 7, as with Third Example described above, the sample support 1C to which the components S1 are introduced is carried in the inner space of the constant temperature bath 80 together with Kimwipes or the like in which triethyl amine or the like that is a basic reagent having volatility (a basifying agent) is absorbed. Accordingly, in a case where the constant temperature bath 80 is activated, the basic reagent absorbed in Kimwipes is gasified, and the inner space of the constant temperature bath 80 is set to a basic environment (a basic atmosphere). Further, in a case where the sample support is heated in the basic environment, the derivatization reaction of the components S1 remaining on the first surface 2a side progresses in a state of being mixed with a part of the derivatizing agent 6. Accordingly, as with the mass spectrometry methods using the sample supports 1 and 1A, high-sensitive mass spectrometry is enabled.

In addition, in the second step of the mass spectrometry method using the sample support not including the basifying agent 7, as with the mass spectrometry method using the sample support 1 (the first embodiment), the sample support 1 may be disposed on the sample S such that the second surface 2b faces the sample S. Accordingly, as with the mass spectrometry method using the sample support 1, the imaging mass spectrometry can be high-sensitive imaging mass spectrometry.

In addition, in the second step of the mass spectrometry method using the sample support not including the basifying agent 7, as with the mass spectrometry method using the sample support 1A (the second embodiment), the solution containing the components of the sample S may be dropped to the plurality of through holes 2c from the second surface 2b side. Accordingly, as with the mass spectrometry method using the sample support 1A, in a case where the derivatizing agent 6 and the substrate 2 have higher affinity for the solution than the conductive layer 5, the solution can be smoothly introduced to the plurality of through holes 2c, compared to a case where the solution is dropped to the plurality of through holes 2c from the first surface 2a side of the substrate 2.

In addition, in the second step of the mass spectrometry method using the sample support not including the basifying agent 7, the solution containing the components may be dropped to the plurality of through holes 2c from the first surface 2a side. Accordingly, since both of the introduction of the solution and the irradiation of the laser light L can be performed from the first surface 2a side, in each of the steps, the sample support 1 may not be reversed. Accordingly, an operation in each of the steps may be facilitated.

In addition, an example has been described in which the derivatizing agent 6 is provided as the coated and dried film, but the derivatizing agent 6, for example, may be provided as an evaporated film or a sputtered film. In this case, the average particle diameter of the crystals of the derivatizing agent 6, for example, is 1 to 50 μm. The average particle diameter of the crystals of the derivatizing agent 6 is a value in a case of being measured by SEM. According to such a configuration, the average particle diameter of the crystals of the derivatizing agent 6 can be relatively decreased, and the distribution of the crystals of the derivatizing agent 6 can be homogeneous. Accordingly, the part 61 of the derivatizing agent 6 that is mixed with the components S1 is homogeneously distributed on the first surface 2a side. Accordingly, the components S1 can be homogeneously derivatized in each position on the first surface 2a side, and spatial resolving power in the mass spectrometry (here, the imaging mass spectrometry) can be increased.

In addition, an example has been described in which the basifying agent 7 is provided as the coated and dried film, but the basifying agent 7, for example, may be provided as an evaporated film or a sputtered film. In this case, the average particle diameter of the crystals of the basifying agent 7, for example, is 1 to 50 μm. The average particle diameter of the crystals of the basifying agent 7 is a value in a case of being measured by SEM. According to such a configuration, the average particle diameter of the crystals of the basifying agent 7 can be relatively decreased, and the distribution of the crystals of the basifying agent 7 can be homogeneous. Accordingly, the environment in which the components S1 are derivatized can be easily basified. In addition, an example has been described in which the basifying agent 7 has crystallizability, but the basifying agent 7 may have volatility.

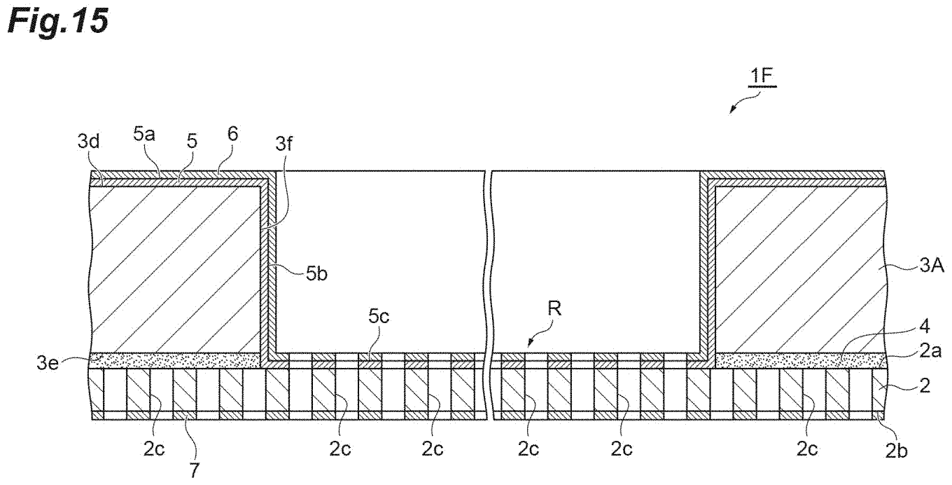

In addition, in the second embodiment, an example has been described in which the derivatizing agent 6 is provided on the second surface 2b side, and the basifying agent 7 is provided on the first surface 2a side, but as illustrated in FIG. 15, in a sample support 1F, the derivatizing agent 6 may be provided on the first surface 2a side, and the basifying agent 7 may be provided on the second surface 2b side. In the first step of the mass spectrometry method, the sample support 1F may be prepared, and in the second step, the solution containing the components of the sample S may be dropped to the plurality of through holes 2c from the first surface 2a side. Accordingly, the damage or the side reaction of the derivatizing agent 6 due to the contact with the basifying agent 7 can be suppressed. In addition, since the components of the sample S are introduced to the plurality of through holes 2c from the first surface 2a side, the contact between the component and the basifying agent 7 can be suppressed, and the damage or the side reaction of the components due to the contact with the basifying agent 7 can be suppressed.

In addition, in the first embodiment, the sample S is not limited to the hydrous sample, and may be a dried sample. In a case where the sample S is the dried sample, a solution for decreasing the viscosity of the sample S (for example, an acetonitrile mixture or the like) can be added to the sample S. Accordingly, for example, the components S1 of the sample S can be moved to the first surface 2a side of the substrate 2 through the plurality of through holes 2c by the capillary action.

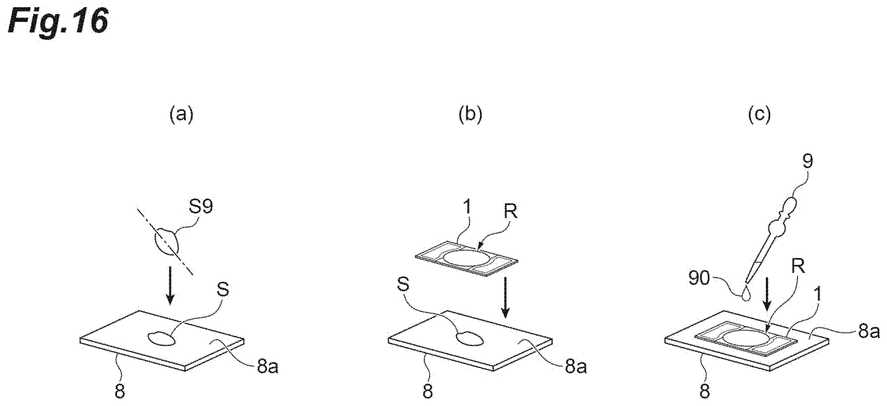

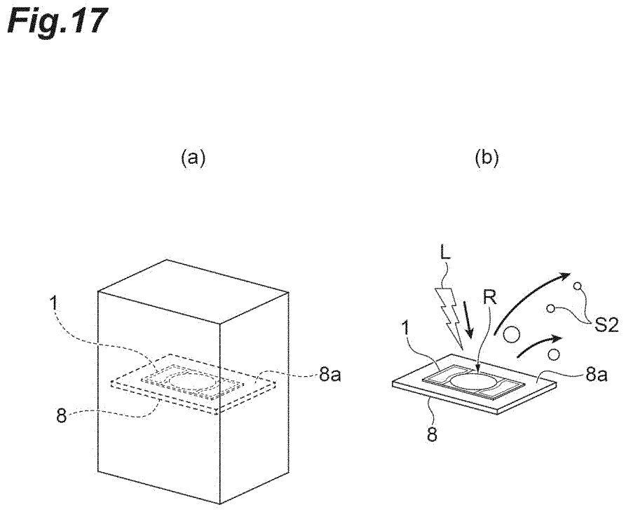

Specifically, first, the sample support 1 is prepared. Subsequently, as illustrated in (a) and (b) in FIG. 16, the components of the sample S are introduced to the plurality of through holes 2c (refer to FIG. 2) of the sample support 1. Specifically, the sample S is disposed on the mounting surface 8a of the glass slide 8. The sample S, for example, is a thin film-shaped biological sample (a dried sample) such as a tissue slice, and is acquired by slicing a biological sample S9. Subsequently, the sample support 1 is disposed on the mounting surface 8a such that the second surface 2b of the sample support 1 (refer to FIG. 2) faces the sample S and the derivatizing agent 6 (refer to FIG. 2) is in contact with the sample S. Subsequently, the sample support 1 is fixed to the glass slide 8 by using a tape having conductivity. Subsequently, as illustrated in (c) in FIG. 16, for example, by using the pipette 9, a solvent 90 is dropped to the measurement region R. Accordingly, the components of the sample S are mixed with the solvent 90 and a part of the derivatizing agent 6, and are moved to the first surface 2a side (refer to FIG. 2) from the second surface 2b side of the substrate 2 through the plurality of through holes 2c. The components of the sample S remain on the first surface 2a side in a state of being mixed with a part of the derivatizing agent 6. Subsequently, as illustrated in (a) in FIG. 17, the components of the sample S are derivatized. Subsequently, as illustrated in (b) in FIG. 17, the components of the sample are ionized. Subsequently, the emitted sample ions S2 are detected by the ion detection unit of the mass spectroscope.

In addition, insofar as the conductive layer 5 is provided on at least the first surface 2a of the substrate 2, the conductive layer 5 may or may not be provided on the second surface 2b of the substrate 2 and on the inner surface of each of the through holes 2c.

In addition, the substrate 2 may have conductivity. In the mass spectrometry method, the first surface 2a may be irradiated with the laser light L while applying a voltage to the substrate 2. In a case where the substrate 2 has conductivity, the conductive layer 5 can be omitted, and the same effects as those in a case of using the sample supports 1 to 1F including the conductive layer 5 described above can be obtained. Note that, irradiating the first surface 2a with the laser light L indicates that the conductive layer 5 is irradiated with the laser light L in a case where the sample support 1 includes the conductive layer 5, and indicates that the first surface 2a of the substrate 2 is irradiated with the laser light L in a case where the substrate 2 has conductivity.

In addition, an example has been described in which the derivatizing agent 6 is directly provided on the second surface 2b, but the derivatizing agent 6, for example, may be indirectly provided on the second surface 2b through a conductive layer or the like.

In addition, an example has been described in which the plurality of through holes 2c are formed on the entire substrate 2, but the plurality of through holes 2c may be formed in at least a portion corresponding to each of the measurement region R and the quantitative region Q in the substrate 2.

In addition, in the first embodiment, the mass spectroscope may be a scanning mass spectroscope, or may be a projection mass spectroscope. In a case of the scanning mass spectroscope, a signal of one pixel having a size corresponding to a spot diameter of the laser light L is acquired for each irradiation of the laser light L by the irradiation unit. That is, the scanning (a change in an irradiation position) and the irradiation of the laser light L are performed for each pixel. On the other hand, in a case of the projection mass spectroscope, a signal of an image (a plurality of pixels) corresponding to the spot diameter of the laser light L is acquired for each irradiation of the laser light L by the irradiation unit. In a case of the projection mass spectroscope, the imaging mass spectrometry can be performed by one irradiation of the laser light L when the entire measurement region R is included in the spot diameter of the laser light L. Note that, in a case of the projection mass spectroscope, as with the scanning mass spectroscope, the scanning and the irradiation of the laser light L can be performed when the entire measurement region R is not included in the spot diameter of the laser light L, and a signal of the entire measurement region R can be acquired.

In addition, in the first embodiment, an example has been described in which the area (the width) of the aperture 3q (the quantitative region Q) is smaller than the area (the width) of the aperture 3c (the measurement region R) when seen from the thickness direction of the substrate 2, but the present disclosure is not limited thereto. The area (the width) of the aperture 3q (the quantitative region Q), for example, may be approximately identical to the area (the width) of the aperture 3c (the measurement region R) when seen from the thickness direction of the substrate 2. In addition, as with the sample support 1A of the second embodiment, in a case where the frame 3A includes the plurality of apertures 3f, a region defined by one aperture 3f in the substrate 2 may be used as the quantitative region.

In addition, in the first embodiment, an example has been described in which the frame 3 has approximately the same outline as that of the substrate 2 when seen from the thickness direction of the substrate 2, but the sample support 1 may include a first substrate that is one size larger than the aperture 3c when seen from a thickness direction of the frame 3, and a second substrate that is one size larger than the aperture 3q when seen from the thickness direction of the frame 3, instead of the substrate 2. Each of the first substrate and the second substrate may be in a circular plate shape.

### REFERENCE SIGNS LIST

1, 1A, 1B, 1C, 1D, 1E, 1F: sample support, 2: substrate, 2a: first surface, 2b: second surface, 2c: through hole, 5: conductive layer, 6: derivatizing agent, 7: basifying agent, L: laser light (energy beam), R: measurement region, S: sample, S1: component, S2: sample ion.

1. A sample support used for ionizing components of a sample, the support comprising:
a substrate including a first surface, a second surface on a side opposite to the first surface, and a plurality of through holes opening to the first surface and the second surface;
a conductive layer provided at least on the first surface; and
a derivatizing agent provided to the plurality of through holes to derivatize the components.

2. The sample support according to claim 1,
wherein the derivatizing agent is provided as a coated and dried film.

3. The sample support according to claim 1,
wherein the derivatizing agent is provided as an evaporated film or a sputtered film.

4. The sample support according to claim 1,
wherein the derivatizing agent contains at least one selected from a pyrylium compound, a carbamate compound, an isothiocyanate compound, N-hydroxysuccinimide ester, and a hydrazide compound.

5. The sample support according to claim 1, further comprising:
a basifying agent configured to basify an environment in which the components are derivatized.

6. The sample support according to claim 5,
wherein the derivatizing agent is provided on the second surface side, and
the basifying agent is provided on the first surface side.

7. The sample support according to claim 5,
wherein the derivatizing agent is provided on the first surface side, and
the basifying agent is provided on the second surface side.

8. The sample support according to claim 5,
wherein the basifying agent is provided as a coated and dried film.

9. The sample support according to claim 5,
wherein the basifying agent is provided as an evaporated film or a sputtered film.

10. The sample support according to claim 5,
wherein the basifying agent contains at least one selected from amines, imines, inorganic bases, an amine-based buffer, an imine-based buffer, and an inorganic base-based buffer.

11. The sample support according to claim 1,
wherein a width of each of the plurality of through holes is 1 to 700 nm.

12. The sample support according to claim 1,
wherein the substrate is formed by anodizing a valve metal or silicon.

13. The sample support according to claim 1,
wherein a plurality of measurement regions respectively including the plurality of through holes are formed on the substrate.

14. A sample support used for ionizing components of a sample, the support comprising:
a conductive substrate including a first surface, a second surface on a side opposite to the first surface, and a plurality of through holes opening to the first surface and the second surface; and
a derivatizing agent provided to the plurality of through holes to derivatize the components.

15. An ionization method, comprising:
a first step of preparing the sample support according to claim 1;
a second step of introducing the components of the sample to the plurality of through holes;
a third step of derivatizing the components by heating the sample support with the components introduced therein in a basic environment; and
a fourth step of ionizing the components by irradiating the first surface with an energy beam while applying a voltage to the conductive layer.

16. The ionization method according to claim 15,
wherein in the second step, the sample support is disposed on the sample such that the second surface faces the sample.

17. The ionization method according to claim 15,
wherein in the second step, a solution containing the components is dropped to the plurality of through holes from the second surface side.

18. The ionization method according to claim 15,
wherein in the second step, a solution containing the components is dropped to the plurality of through holes from the first surface side.

19. An ionization method, comprising:
a first step of preparing the sample support according to claim 5;
a second step of introducing the components of the sample to the plurality of through holes;
a third step of derivatizing the components by heating the sample support with the components introduced therein; and
a fourth step of ionizing the components by irradiating the first surface with an energy beam while applying a voltage to the conductive layer.

20. The ionization method according to claim 19,
wherein in the first step, the sample support configured such that the derivatizing agent is provided on the second surface side and the basifying agent is provided on the first surface side is prepared, and
in the second step, the sample support is disposed on the sample such that the second surface faces the sample.

21. The ionization method according to claim 19,
wherein in the first step, the sample support configured such that the derivatizing agent is provided on the second surface side and the basifying agent is provided on the first surface side is prepared, and
in the second step, a solution containing the components is dropped to the plurality of through holes from the second surface side.

22. The ionization method according to claim 19,
wherein in the first step, the sample support configured such that the derivatizing agent is provided on the first surface side and the basifying agent is provided on the second surface side is prepared, and
in the second step, a solution containing the components is dropped to the plurality of through holes from the first surface side.

23. An ionization method, comprising:
a first step of preparing the sample support according to claim 14;
a second step of introducing the components of the sample to the plurality of through holes;
a third step of derivatizing the components by heating the sample support with introduced the components in a basic environment; and
a fourth step of ionizing the components by irradiating the first surface with an energy beam while applying a voltage to the substrate.

24. A mass spectrometry method, comprising:
each of the steps of the ionization method according to claim 15; and
a fifth step of detecting the ionized components.
